(19) United States
(12) Patent Application Publication
(10) Pub. No.: US 2023/0309633 A1
(43) Pub. Date: Oct. 5, 2023

(54) Breathable and Puncture Resistant Laminates

(71) Applicant: Berry Global, Inc., Evansville, IN (US)

(72) Inventors: Elena Cordublas, Barcelona (ES); Kay Alsleben, Lutherstadt Eisleben (DE)

(21) Appl. No.: 18/128,648

(22) Filed: Mar. 30, 2023

Related U.S. Application Data
(60) Provisional application No. 63/325,868, filed on Mar. 31, 2022.

(51) Int. Cl. A41D 13/00; A41D 31/102; A41D 31/02; A41H 43/04

(52) U.S. Cl. CPC A41D 13/0002; A41D 31/102; A41D 31/02; A41H 43/04; A41D 2500/30; A41D 2500/50

(57) ABSTRACT

Laminates providing a simultaneous benefit of desirable breathability and puncture resistance are provided. The laminates include a nonwoven fabric and a vapor-permeable and liquid impermeable (VPLI) film bonded to the nonwoven fabric by an adhesive layer that is located between the nonwoven fabric and the VPLI film. The VPLI film has (i) a moisture vapor transmission rate (MVTR) of at least about 2000 Mocon or g/m²/24 hours as determined according to EDNA/INDA Worldwide Strategic Methods: WSP 70.4(08) and/or (ii) a puncture resistance of at least about 5 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min.

### CROSS-REFERENCE TO RELATED APPLICATIONS

This application claims priority under 35 U.S.C. § 119 to U.S. Provisional Application No. 63/325,868 filed Mar. 31, 2022, which is expressly incorporated by reference herein in its entirety.

### TECHNICAL FIELD

Embodiments of the presently-disclosed invention relate generally to breathable and puncture resistant laminates that may by suitable for a variety of protective clothing articles. The laminates include a nonwoven fabric and a vapor-permeable and liquid impermeable (VPLI) film bonded to the nonwoven fabric by an adhesive layer that is located between the nonwoven fabric and the VPLI film, in which the VPLI has both desirable breathability and puncture resistance.

### BACKGROUND

Articles of protective clothing may come in a variety of different configurations including, for example, coveralls, gowns, smocks and other garments whose purpose is either to protect a wearer against exposure to something in the wearer's surroundings, or to protect the wearer's surroundings against being contaminated by the wearer. Examples of articles of protective clothing may include, for example, suits worn in manufacturing cleanrooms, medical suits and gowns, dirty job coveralls, and suits worn for protection against liquids or particulates. The particular applications for which an article of protective clothing is suitable depends upon the composition of the material used to make the article of protective clothing and/or the way that the pieces of article of protective clothing are held together in the garment. For example, one type of material may be excellent for use in hazardous chemical protection applications, while being too expensive or uncomfortable for use in medical applications (e.g., gowns). Another material, for example, may be lightweight and breathable enough for use in clean room applications, but not be durable enough for dirty job applications.

Therefore, there remains a need in the art for materials, such as a film and nonwoven laminate, that simultaneously provide a desirable level of breathability and barrier properties (e.g., hydrohead and/or puncture resistance) such that these material may be used over a broad range of applications.

### SUMMARY OF INVENTION

One or more embodiments of the invention may address one or more of the aforementioned problems. Certain embodiments according to the invention provide a laminate including a nonwoven fabric and a vapor-permeable and liquid impermeable (VPLI) film bonded to the nonwoven fabric. The VPLI film may be bonded directly or indirectly to the nonwoven fabric by an adhesive layer (e.g., one or more hot melt adhesives) located between the nonwoven fabric and the VPLI film. In accordance with certain embodiments of the invention, the VPLI film may have (i) a moisture vapor transmission rate (MVTR) of at least about 2000 Mocon or g/m²/24 hours (e.g., from 2000 to 10000 Mocon or g/m²/24 hours) as determined according to EDNA/INDA Worldwide Strategic Methods: WSP 70.4(08), such as at least about any of the following: 2000, 2200, 2400, 2500, 2600, 2800, 3000, 3200, 3400, 3500, 3600, 3800, 4000, 4200, 4400, 4500, 4600, 4800, and 5000 Mocon or g/m²/24 hours as determined according to WSP 70.4(08), and/or at most about any of the following: 10000, 9000, 8000, 7500, 7400, 7200, 7000, 6800, 6600, 6500, 6400, 6200, 6000, 5800, 5600, 5500, 5400, 5200, and 5000 Mocon or g/m²/24 hours as determined according to WSP 70.4(08), and/or (ii) a puncture resistance of at least about 5 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min, such as at least about any of the following: 5, 6 7, 8, 9, 10, 12, 14, and 15 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min, and/or at most about any of the following: 50, 45, 40, 35, 30, 25, 20, 18, 16, and 15 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min.

In another aspect, the invention provides a method of forming a laminate, in which the method may comprise the following steps: (i) providing or forming a nonwoven fabric; (ii) providing or forming a vapor-permeable and liquid impermeable (VPLI) film; and (iii) directly or indirectly bonding the nonwoven fabric to the VPLI film via an adhesive layer. The VPLI film, in accordance with certain embodiments of the invention, may have (i) a moisture vapor transmission rate (MVTR) of at least about 2000 Mocon or g/m²/24 hours (e.g., from 2000 to 10000 Mocon or g/m²/24 hours) as determined according to EDNA/INDA Worldwide Strategic Methods: WSP 70.4(08), such as at least about any of the following: 2000, 2200, 2400, 2500, 2600, 2800, 3000, 3200, 3400, 3500, 3600, 3800, 4000, 4200, 4400, 4500, 4600, 4800, and 5000 Mocon or g/m²/24 hours as determined according to WSP 70.4(08), and/or at most about any of the following: 10000, 9000, 8000, 7500, 7400, 7200, 7000, 6800, 6600, 6500, 6400, 6200, 6000, 5800, 5600, 5500, 5400, 5200, and 5000 Mocon or g/m²/24 hours as determined according to WSP 70.4(08), and/or (ii) a puncture resistance of at least about 5 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min, such as at least about any of the following: 5, 6 7, 8, 9, 10, 12, 14, and 15 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min, and/or at most about any of the following: 50, 45, 40, 35, 30, 25, 20, 18, 16, and 15 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min.

In yet another aspect, the present invention provides an article of protective clothing. The article of protective clothing may be formed at least partially (e.g., substantially all with the exception of any stitching or connecting or closing means) from a laminate as described and disclosed herein. The article of protective clothing, for example, may comprise coveralls, gowns, smocks, pants, headwear, and shoe covers.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention relates generally to laminates that exhibit a simultaneous level of desirable breathability and barrier properties (e.g., hydrohead and/or puncture resistance). In this regard, the laminates may by suitable for use in the formation of a variety of protective clothing articles, which may be utilized by an wearer in a wide range of task-related activities or applications. The laminates, in accordance with certain embodiments of the invention, include a nonwoven fabric and a vapor-permeable and liquid impermeable (VPLI) film bonded to the nonwoven fabric by an adhesive layer that is located between the nonwoven fabric and the VPLI film. The VPLI film may comprise a single layer film or a multi-layer film, in which the VPLI has both desirable breathability and puncture resistance. The single layer film, for example, may comprise a microporous film, while the multi-layer film may comprise at least one individual layer that is a microporous layer. In accordance with certain embodiments of the invention, each of the individual layers of the multi-layer film (e.g., a multi-layer VPLI) may be microporous. In accordance with certain embodiments of the invention, the multi-layer film may be co-extruded.

The terms “substantial” or “substantially” may encompass the whole amount as specified, according to certain embodiments of the invention, or largely but not the whole amount specified (e.g., 95%, 96%, 97%, 98%, or 99% of the whole amount specified) according to other embodiments of the invention.

The terms “polymer” or “polymeric”, as used interchangeably herein, may comprise homopolymers, copolymers, such as, for example, block, graft, random, and alternating copolymers, terpolymers, etc., and blends and modifications thereof. Furthermore, unless otherwise specifically limited, the term “polymer” or “polymeric” shall include all possible structural isomers; stereoisomers including, without limitation, geometric isomers, optical isomers or enantionmers; and/or any chiral molecular configuration of such polymer or polymeric material. These configurations include, but are not limited to, isotactic, syndiotactic, and atactic configurations of such polymer or polymeric material. The term “polymer” or “polymeric” shall also include polymers made from various catalyst systems including, without limitation, the Ziegler-Natta catalyst system and the metallocene/single-site catalyst system. The term “polymer” or “polymeric” shall also include, in according to certain embodiments of the invention, polymers produced by fermentation process or biosourced.

The term “linear low density polyethylene” (LLDPE), as used herein refers to a substantially linear polymer (polyethylene) including more than 50% of ethylene monomers by weight (more than 60%, more than 70%, more than 80%, more than 90%, more than 95%, more that 98%, or 100% ethylene monomers by weight), with significant numbers of short branches. LLDPE may be considered to differ structurally from conventional low-density polyethylene (LDPE) due to the of the absence of long chain branching. In accordance with certain embodiments of the invention, the linearity of LLDPE may result from the different manufacturing processes of forming LLDPE and LDPE. Additionally, LLDPE may have a narrower molecular weight distribution as compared to conventional LDPE, which in combination with the linear structure, provides significantly different rheological properties. LLDPE may have a density from about 0.9 to 0.935 g/cm³, such as at least about any of the following: 0.9, 0.905, 0.91, 0.912, 0.915, 0.916, 0.918, and 0.92 g/cm³, and/or at most about any of the following: 0.935, 0.93, 0.928, 0.925, 0.922, and 0.92 g/cm³.

The term “non-linear low density polyethylenes”, as used herein refers to a polymer (polyethylene) including more than 50% of ethylene monomers by weight (more than 60%, more than 70%, more than 80%, more than 90%, more than 95%, more that 98%, or 100% ethylene monomers by weight), with significant numbers of long chain branches. Non-linear low density polyethylenes may have a density from about 0.9 to 0.935 g/cm³, such as at least about any of the following: 0.9, 0.905, 0.91, 0.912, 0.915, 0.916, 0.918, and 0.92 g/cm³, and/or at most about any of the following: 0.935, 0.93, 0.928, 0.925, 0.922, and 0.92 g/cm³.

The terms “branching” or “branches”, as used herein, refers to the structure of a polymer and can be broadly classified as short-chain branching (SCB), referring to branches that have only a few carbon atoms and are much smaller than the backbone of the linear molecule to which they are attached, and long-chain branching (LCB), where the length of the branch is comparable to that of the backbone.

The term “high density polyethylene” (HDPE), as used herein refers to a polymer including more than 50% of ethylene monomers by weight (more than 60%, more than 70%, more than 80%, more than 90%, more than 95%, more that 98%, or 100% ethylene monomers by weight), in which the polymer has a density in the range of 0.945 to 0.980 g/cm³, such as at least about any of the following: 0.945, 0.95, 0.955, and 0.96 g/cm³, and/or at most about any of the following: 0.98, 0.97, and 0.96 g/cm³. A high-density polyethylene may have a melt flow rate of at least 1 g/10 minutes, such as from about any of the following: 1, 3, 4, 5, 6, 8, and 10 g/10 minutes, and/or at most about any of the following: 20, 18, 15, 12, and 10 g/10 minutes. In accordance with certain embodiments of the invention, the HDPE may be substantially free of any long chain branching. Substantially free of any long chain branching, as used herein, refers to a polyethylene preferably substituted with less than about 0.1 long chain branching per 1000 total carbons, and more preferably, less than about 0.01 long chain branching per 1000 total carbons. The HDPE may have a molecular weight distribution “MWD” in the range of 6 to 25. The term “molecular weight distribution” or “MWD,” as used herein, refers to the ratio of weight average molecular weight (Mw) to number average molecular weight (Mn), that is (Mw/Mn).

The term “ethylene/α-olefin copolymers”, as used herein refers to copolymers including ethylene monomers and α-olefin monomers, in which the copolymers include more than 50% of ethylene monomers by weight (more than 60%, more than 70%, more than 80%, more than 90%, more than 95%, more that 98%, or more than 99% ethylene monomers by weight). Suitable α-olefin monomers include a C3-C20 α-olefin monomers, such as at least about any of the following: C3, C4, C5, C6, C7, and C8 α-olefin monomers, and/or at most about any of the following: C20, C18, C15, C12, C10, and C8 α-olefin monomers. Example α-olefin monomers include propylene, 1-butene, 1-pentene, 1-hexene, 4-methyl-1-pentene, 1-heptene, 1-octene, 1-nonene and 1-decene. Ethylene/α-olefin copolymers may have a density in the range of 0.91 to 0.935 g/cm³, such as at least about any of the following: 0.91, 0.912, 0.915, 0.916, 0.918, and 0.92 g/cm³, and/or at most about any of the following: 0.935, 0.93, 0.928, 0.925, 0.922, and 0.92 g/cm³. Ethylene/α-olefin copolymers may have a melt flow rate of at least 1 g/10 minutes, such as from about any of the following: 1, 3, 4, 5, 6, 8, and 10 g/10 minutes, and/or at most about any of the following: 20, 18, 15, 12, and 10 g/10 minutes.

The terms “nonwoven” and “nonwoven web”, as used herein, may comprise a web having a structure of individual fibers, filaments, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, needle-punching, hydroentangling, air-laid, and bonded carded web processes. A “nonwoven web”, as used herein, may comprise a plurality of individual fibers that have not been subjected to a consolidating process. In certain instances, the “nonwoven web” may comprises a plurality of layers, such as one or more spunbond layers and/or one or more meltblown layers. For instance, a “nonwoven web” may comprises a spunbond-meltblown-spunbond structure.

The terms “fabric” and “nonwoven fabric”, as used herein, may comprise a web of fibers in which a plurality of the fibers are mechanically entangled or interconnected, fused together, and/or chemically bonded together. For example, a nonwoven web of individually laid fibers may be subjected to a bonding or consolidation process to bond at least a portion of the individually fibers together to form a coherent (e.g., united) web of interconnected fibers.

The term “consolidated” and “consolidation”, as used herein, may comprise the bringing together of at least a portion of the fibers of a nonwoven web into closer proximity or attachment there-between (e.g., thermally fused together, chemically bonded together, and/or mechanically entangled together) to form a bonding site, or bonding sites, which function to increase the resistance to external forces (e.g., abrasion and tensile forces), as compared to the unconsolidated web. The bonding site or bonding sites, for example, may comprise a discrete or localized region of the web material that has been softened or melted and optionally subsequently or simultaneously compressed to form a discrete or localized deformation in the web material. Furthermore, the term “consolidated” may comprise an entire nonwoven web that has been processed such that at least a portion of the fibers are brought into closer proximity or attachment there-between (e.g., thermally fused together, chemically bonded together, and/or mechanically entangled together), such as by thermal bonding or mechanical entanglement (e.g., hydroentanglement) as merely a few examples. Such a web may be considered a “consolidated nonwoven”, “nonwoven fabric” or simply as a “fabric” according to certain embodiments of the invention.

The term “staple fiber”, as used herein, may comprise a cut fiber from a filament. In accordance with certain embodiments, any type of filament material may be used to form staple fibers. For example, staple fibers may be formed from polymeric fibers, and/or elastomeric fibers. Non-limiting examples of materials may comprise polyolefins (e.g., a polypropylene or polypropylene-containing copolymer), polyethylene terephthalate, and polyamides. The average length of staple fibers may comprise, by way of example only, from about 2 centimeter to about 15 centimeter.

The term “spunbond”, as used herein, may comprise fibers which are formed by extruding molten thermoplastic material as filaments from a plurality of fine, usually circular, capillaries of a spinneret with the diameter of the extruded filaments then being rapidly reduced. According to an embodiment of the invention, spunbond fibers are generally not tacky when they are deposited onto a collecting surface and may be generally continuous as disclosed and described herein. It is noted that the spunbond used in certain composites of the invention may include a nonwoven described in the literature as SPINLACE®. Spunbond fibers, for example, comprise continuous fibers.

As used herein, the term “continuous fibers” refers to fibers which are not cut from their original length prior to being formed into a nonwoven web or nonwoven fabric. Continuous fibers may have average lengths ranging from greater than about 15 centimeters to more than one meter, and up to the length of the web or fabric being formed. For example, a continuous fiber, as used herein, may comprise a fiber in which the length of the fiber is at least 1,000 times larger than the average diameter of the fiber, such as the length of the fiber being at least about 5,000, 10,000, 50,000, or 100,000 times larger than the average diameter of the fiber.

The term “meltblown”, as used herein, may comprise fibers formed by extruding a molten thermoplastic material through a plurality of fine die capillaries as molten threads or filaments into converging high velocity, usually hot, gas (e.g. air) streams which attenuate the filaments of molten thermoplastic material to reduce their diameter, which may be to microfiber diameter, according to certain embodiments of the invention. According to an embodiment of the invention, the die capillaries may be circular. Thereafter, the meltblown fibers are carried by the high velocity gas stream and are deposited on a collecting surface to form a web of randomly disbursed meltblown fibers. Meltblown fibers may comprise microfibers which may be continuous or discontinuous and are generally tacky when deposited onto a collecting surface. Meltblown fibers, however, are shorter in length than those of spunbond fibers.

The term “layer”, as used herein, may comprise a generally recognizable combination of similar material types and/or functions existing in the X-Y plane.

The term “multi-component fibers”, as used herein, may comprise fibers formed from at least two different polymeric materials or compositions (e.g., two or more) extruded from separate extruders but spun together to form one fiber. The term “bi-component fibers”, as used herein, may comprise fibers formed from two different polymeric materials or compositions extruded from separate extruders but spun together to form one fiber. The polymeric materials or polymers are arranged in a substantially constant position in distinct zones across the cross-section of the multi-component fibers and extend continuously along the length of the multi-component fibers. The configuration of such a multi-component fiber may be, for example, a sheath/core arrangement wherein one polymer is surrounded by another, an eccentric sheath/core arrangement, a side-by-side arrangement, a pie arrangement, or an “islands-in-the-sea” arrangement, each as is known in the art of multicomponent, including bicomponent, fibers.

The term “machine direction” or “MD”, as used herein, comprises the direction in which the fabric produced or conveyed. The term “cross-direction” or “CD”, as used herein, comprises the direction of the fabric substantially perpendicular to the MD.

As used herein, the term “aspect ratio”, comprise a ratio of the length of the major axis to the length of the minor axis of the cross-section of the fiber in question.

The term “filler”, as used herein, may comprise particles or aggregates of particles and other forms of materials that can be added to a polymeric film blend. According to certain embodiments of the invention, a filler may not substantially chemically interfere with or adversely affect the extruded film. According to certain embodiments of the invention, the filler is capable of being uniformly dispersed throughout the film or a layer comprised in a multilayer film. Fillers, for example, may comprise particulate inorganic materials such as, for example, calcium carbonate, various kinds of clay, silica, alumina, barium sulfate, sodium carbonate, talc, magnesium sulfate, titanium dioxide, zeolites, aluminum sulfate, cellulose-type powders, diatomaceous earth, magnesium sulfate, magnesium carbonate, barium carbonate, kaolin, mica, carbon, calcium oxide, magnesium oxide, aluminum hydroxide, glass particles, and the like, and organic particulate materials such as high-melting point polymers (e.g., TEFLON® and KEVLAR® from E.I. DuPont de Nemours and Company), pulp powder, wood powder, cellulose derivatives, chitin and chitin derivatives, and the like. Filler particles may optionally be coated with a fatty acid, such as stearic acid or reduced stearic acid, or a larger chain fatty acid, such as behenic acid. Without intending to be bound by theory, coated filler particles may facilitate the free flow of the particles (in bulk) and their ease of dispersion into the polymer matrix, according to certain embodiments of the invention.

Certain embodiments according to the invention provide a laminate including a nonwoven fabric and a vapor-permeable and liquid impermeable (VPLI) film bonded to the nonwoven fabric. The VPLI film may be bonded directly or indirectly to the nonwoven fabric by an adhesive layer (e.g., one or more hot melt adhesives) located between the nonwoven fabric and the VPLI film. In accordance with certain embodiments of the invention, the VPLI film may have (i) a moisture vapor transmission rate (MVTR) of at least about 2000 Mocon or g/m²/24 hours (e.g., from 2000 to 10000 Mocon or g/m²/24 hours) as determined according to EDNA/INDA Worldwide Strategic Methods: WSP 70.4(08), such as at least about any of the following: 2000, 2200, 2400, 2500, 2600, 2800, 3000, 3200, 3400, 3500, 3600, 3800, 4000, 4200, 4400, 4500, 4600, 4800, and 5000 Mocon or g/m²/24 hours as determined according to WSP 70.4(08), and/or at most about any of the following: 10000, 9000, 8000, 7500, 7400, 7200, 7000, 6800, 6600, 6500, 6400, 6200, 6000, 5800, 5600, 5500, 5400, 5200, and 5000 Mocon or g/m²/24 hours as determined according to WSP 70.4(08), and/or (ii) a puncture resistance of at least about 5 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min, such as at least about any of the following: 5, 6 7, 8, 9, 10, 12, 14, and 15 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min, and/or at most about any of the following: 50, 45, 40, 35, 30, 25, 20, 18, 16, and 15 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min.

In accordance with certain embodiments of the invention, the nonwoven fabric of the laminate may not be particularly limited. For example, the nonwoven fabric may comprise at least one spunbond layer, at least one meltblown layer, at least one carded layer, or any combinations thereof. For example, the nonwoven fabric may comprise a spunbond-meltblow-spunbond structure. In accordance with certain embodiments of the invention, the nonwoven fabric comprises one or more spunbond layers. For instance, the nonwoven fabric may comprise a single spunbond layer or a plurality of spunbond layers (e.g., multiple spunbond beams forming spunbond webs followed by consolidation may form the nonwoven fabric or a plurality of pre-formed spunbond nonwoven fabrics may be bonded together to define the nonwoven fabric). In accordance with certain embodiments of the invention, the nonwoven fabric may comprises from about 50 to about 100% by weight of spunbond fibers, such as at least about any of the following: 50, 60, 70, and 75% by weight of spunbond fibers, and/or at most about any of the following: 100, 98, 95, 90, 85, 80, and 75% by weight of spunbond fibers. Additionally or alternatively, the nonwoven fabric may have a basis weight from about 40 to about 150 grams-per-square meter (gsm), such as at least about any of the following: 40, 45, 50, 55, 60, 65, 70, 75, 80, 85, 90, 95, and 100 gsm, and/or at most about any of the following: 150, 140, 130, 120, 110, and 100 gsm.

In accordance with certain embodiments of the invention, the nonwoven fabric may have a bonded area from about 1% to about 35%, such as at least about any of the following: 1, 5, 8, 10, 12, 15, 18, and 20%, and/or at most about any of the following: 35, 30, 28, 25, 22, and 20%. The bonded area, for example, may be defined by a plurality of separate bonded sites, such as thermal bonded sites, ultrasonically bonded sites, or adhesively formed bonded sites.

The nonwoven fabric, in accordance with certain embodiments of the invention, may include a plurality of fibers comprising a plurality of mono-component fibers, a plurality of multi-component fibers (e.g., as bi-component fibers), or combinations thereof. In accordance with certain embodiments of the invention, the nonwoven fabric may comprises a plurality of multi-component fibers having a sheath/core configuration, a side-by-side configuration, a pie configuration, an islands-in-the-sea configuration, a multi-lobed configuration, or any combinations thereof. In accordance with certain embodiments of the invention, the plurality of fibers may comprise from about 50 to about 100% by weight of mono-component fibers, such as at least about any of the following: 50, 60, 70, and 75% by weight of mono-component fibers, and/or at most about any of the following: 100, 98, 95, 90, 85, 80, and 75% by weight of mono-component fibers.

In accordance with certain embodiments of the invention, the plurality of fibers may comprise continuous fibers (e.g., spunbond fibers), discontinuous fibers (e.g., meltblown fibers), staple fibers, or any combination thereof. Additionally or alternatively, the plurality of fibers may comprise a round cross-section, a non-round cross-section, or a combination thereof. Fibers having a non-round cross-section may, for example, have an aspect ratio of greater than 1.5:1, such as at least about 1.5:1, 2:1, 3:1, 4:1, and 5:1, and/or at most about any of the following: 10:1, 9:1, 8:1, 7:1, 6:1, and 5:1. Fibers having a round cross-section may have an aspect ratio, for example, from about 0.8:1 to about 1.2:1, such as at least about any of the following: 0.8:1, 0.9:1, and 1:1, and/or at most about any of the following: 1.2:1, 1.1:1, and 1:1.

The plurality of fibers, in accordance with certain embodiments of the invention, may comprise a polymeric composition comprising a polyolefin, a polyester, a polyamide, or any combination thereof. The polyolefin, for example, may comprise a polyethylene, such as a high density polyethylene, a copolymer including more than 50% by weight of ethylene monomers, a polypropylene, a copolymer including more than 50% by weight of propylene monomers, or a combination thereof. In accordance with certain embodiments of the invention, the plurality of fibers comprises or consist of continuous spunbond fibers comprising a high density polyethylene.

In accordance with certain embodiments of the invention, the polyolefin may comprises a melt flow rate (MFR) of from about 5 to about 30 g/10 min as determined by ASTM D1238 (190 C°/2.16 kg), such as at least about any of the following: 5, 6, 8, 10, 12, 14, and 15 g/10 min as determined by ASTM D1238 (190 C°/2.16 kg), and/or at most about any of the following: 30, 28, 25, 22, 20, 18, 16, and 15 g/10 min g/10 min as determined by ASTM D1238 (190 C°/2.16 kg). Additionally or alternatively, the polyolefin may comprise a density of from about 0.88 to about 0.98 g/cm³ as determined by ASTM D792, such as at least about any of the following: 0.88, 0.89, 0.9, 0.91, 0.92, and 0.93 g/cm³ as determined by ASTM D792, and/or at most about any of the following: 0.98, 0.97, 0.96, 0.95, 0.94, and 0.93 g/cm³ as determined by ASTM D792.

In accordance with certain embodiments of the invention, the nonwoven fabric may include one or more additives, such as one or more antistatic additives, one or more hydrophobic additives (e.g., surfactant that renders the plurality of fibers hydrophobic), or combinations thereof. The additives, for example, may comprise a topical antistatic additive disposed onto the nonwoven fabric, a melt-added antistatic agent disposed within the polymeric composition forming the plurality of fibers, or both. Additionally or alternatively, the one or more additives may comprise from about 0.05 to about 3% by weight of the nonwoven fabric.

In accordance with certain embodiments of the invention, the VPLI film may comprise a single layer film having a single-layer-polymeric composition (e.g., a microporous film). The single layer film may have a basis weight from about 10 to about 100 gsm, such as at least about any of the following: 10, 12, 15, 18, 20, 22, 25, 28, 30, 35, and 40 gsm, and/or at most about any of the following: 100, 90, 80, 70, 60, 50, and 40 gsm; and/or a total thickness from about 10 to about 100 microns, such as at least about any of the following: 10, 12, 15, 18, 20, 22, 25, 28 and 30 microns, and/or at most about any of the following: 100, 80, 60, 40, 35, and 30 microns.

The single-layer-polymeric composition, for example, may comprise a polymer-phase (e.g., polymer matrix of one or more polymers) and a filler dispersed throughout the polymer-phase. In accordance with certain embodiments of the invention, the single-layer-polymeric composition may comprise from about 20 to about 70% by weight of filler, such as at least about any of the following: 20, 25, 30, 35, 40, and 45% by weight of filler, and/or at most about any of the following: 70, 65, 60, 55, 50, and 45% by weight of filler. The filler, for example, may comprise an inorganic filler, such as calcium carbonate, as noted previously.

In accordance with certain embodiments of the invention, the polymer-phase may comprise a polyethylene or a blend of a plurality of polyethylenes (e.g., polyethylene polymers). For example, the polymer-phase may comprise a blend of polyethylenes (e.g., polyethylene polymers) that includes one or more of the following: (i) one or more linear low density polyethylenes (LLDPE); (ii) one or more non-linear low density polyethylenes; (iii) optionally one or more high density polyethylenes (HDPE); and (iv) optionally one or more ethylene/α-olefin copolymers. In accordance with certain embodiments of the invention, the polymer-phase may include at least one polymer from each of groups (i) through (iv), in which each polymer is unique from the others (e.g., the ethylene/α-olefin copolymer is different from the LLDPE). Alternatively, the polymer-phase may be devoid of a HDPE and/or an ethylene/α-olefin copolymer.

In accordance with certain embodiments of the invention, the VPLI may comprise from about 20 to about 50% by weight of the one or more LLDPEs, such as at least about any of the following: 20, 22, 25, 28, 30, 32, and 35% by weight of the one or more LLDPEs, and/or at most about any of the following: 50, 48, 45, 42, 40, 38, and 35% by weight of the one or more LLDPEs. Additionally or alternatively, the polymer-phase may comprise from about 40 to about 75% by weight of the one or more LLDPEs, such as at least about any of the following: 40, 42, 44, 46, 48, 50, 52, 54, 56, 58, and 60% by weight of the one or more LLDPEs, and/or at most about any of the following: 75, 72, 70, 68, 66, 64, 62, and 60% by weight of the one or more LLDPEs.

In accordance with certain embodiments of the invention, the VPLI may comprise from about 5 to about 30% by weight of the one or more ethylene/α-olefin copolymers, such as at least about any of the following: 5, 8, 10, 12, 15, 18, and 20% by weight of the one or more ethylene/α-olefin copolymers, and/or at most about any of the following: 30, 28, 25, 22, and 20% by weight of the one or more ethylene/α-olefin copolymers. Additionally or alternatively, the polymer-phase may comprise from about 10 to about 45% by weight of the one or more ethylene/α-olefin copolymers, such as at least about any of the following: 10, 12, 15, 18, 20, 22, 25, 28, and 30% by weight of the one or more ethylene/α-olefin copolymers, and/or at most about any of the following: 45, 42, 40, 38, 36, 34, 32, and 30% by weight of the one or more ethylene/α-olefin copolymers.

In accordance with certain embodiments of the invention, the VPLI may comprise from about 1 to about 15% by weight of the one or more HDPEs, such as at least about any of the following: 1, 2, 3, 4, 5, 6, 8, and 10% by weight of the one or more HDPEs, and/or at most about any of the following: 15, 14, 13, 12, and 10% by weight of the one or more HDPEs. Additionally or alternatively, the polymer-phase may comprise from about 5 to about 25% by weight of the one or more HDPEs, such as at least about any of the following: 5, 6, 7, 8, 9, 10, 12, and 15% by weight of the one or more HDPEs, and/or at most about any of the following: 25, 22, 20, 18, and 15% by weight of the one or more HDPEs.

In accordance with certain embodiments of the invention, the VPLI may comprises from about 1 to about 15% by weight of the one or more non-linear low density polyethylenes, such as at least about any of the following: 1, 2, 3, 4, 5, 6, 8, and 10% by weight of the one or more HDPEs, and/or at most about any of the following: 15, 14, 13, 12, and 10% by weight of the one or more non-linear low density polyethylenes. Additionally or alternatively, the polymer-phase may comprise from about 5 to about 25% by weight of the one or more non-linear low density polyethylenes, such as at least about any of the following: 5, 6, 7, 8, 9, 10, 12, and 15% by weight of the one or more HDPEs, and/or at most about any of the following: 25, 22, 20, 18, and 15% by weight of the one or more non-linear low density polyethylenes.

In accordance with certain embodiments of the invention, the polymer-phase may comprise a first weight ratio between the one or more LLDPEs and the one or more HPDEs is from about 2:1 to about 7:1, such as at least about any of the following: 2:1, 2.5:1, 3:1, 3.5:1, 4:1, 4.5:1, and 5:1, and/or at most about any of the following: 7:1, 6.5:1, 6:1, 5.5:1, and 5:1. Additionally or alternatively, the polymer-phase may comprise a second weight ratio between the one or more LLDPEs and the one or more ethylene/α-olefin copolymers is from about 1:1 to about 4:1, such as at least about any of the following: 1:1, 1.25:1, 1.5:1, 1.75:1, 2:1, and 2.25:1, and/or at most about any of the following: 4:1, 3.75:1, 3.5:1, 3.25:1, 3:1, 2.75:1, 2.5:1, and 2.25:1. Additionally or alternatively, the polymer-phase may comprise a third weight ratio between the one or more ethylene/α-olefin copolymers and the one or more HDPEs is from about 1:1 to about 4:1, such as at least about any of the following: 1:1, 1.25:1, 1.5:1, 1.75:1, 2:1, 2.25:1, 2.5:1, and/or at most about any of the following: 4:1, 3.75:1, 3.5:1, 3.25:1, 3:1, 2.75:1, and 2.5:1.

The VPLI film, in accordance with certain embodiments of the invention, may comprise a multi-layer film (e.g., a multi-layer VPLI film). In this regard, the multi-layer film may comprise from 2 to about 8 discrete or individual layers (e.g., 2, 3, 4, 5, 6, 7, or 8 discrete or individual) layers) that may be coextruded together to define the multi-layer film. For instance, the multi-layer film may include a base layer, a first skin layer, and a second skin layer, wherein the base layer is located directly or indirectly between the first skin layer and the second skin layer. In accordance with certain embodiments of the invention, at least one of the first skin layer, the second skin layer, and the base layer comprise a microporous layer, such as each of the first skin layer, the second skin layer, and the base layer comprise respective microporous layers of the multi-layer film. In this regard, each individual or discrete layer of the multi-layer film may be microporous in nature.

In accordance with certain embodiments of the invention, the first skin layer comprises a first-skin-layer polymeric composition, the second skin layer comprises a second-skin-layer polymeric composition, and the base layer comprises a base-layer polymeric composition, in which each of the first-skin-layer polymeric composition, the second-skin-layer polymeric composition, and the base-layer polymeric composition may comprise respective polymer-phases and respective fillers dispersed throughout the respective polymer-phases. In this regard, the first-skin-layer polymeric composition, the second-skin-layer polymeric composition, and the base-layer polymeric composition may be selected or formulated independent of each other polymeric composition or alternatively the first-skin-layer polymeric composition, the second-skin-layer polymeric composition, and the base-layer polymeric composition may be identical to each other (e.g., same polymeric blend of polymers, same percentage of filler, same type and amount of any additives, etc.). In accordance with certain embodiments of the invention, the first-skin-layer polymeric composition may include a first polymer-phase and a first-layer filler, the second-skin-layer polymeric composition may include a second polymer-phase and a second-layer filler, and the base-layer polymeric composition may include a base polymer-phase and a base-layer filler.

In accordance with certain embodiments of the invention, one or more of the first-skin-layer polymeric composition, the second-skin-layer polymeric composition, and the base-layer polymeric composition independently from each other may comprise from about 20 to about 70% by weight of the respective filler, such as at least about any of the following: 20, 25, 30, 35, 40, and 45% by weight of the respective filler, and/or at most about any of the following: 70, 65, 60, 55, 50, and 45% by weight of the respective filler. As noted above, the respective filler from one layer to the next may be identical of different from another. For example, each of the respective fillers may comprises an inorganic filler, such as calcium carbonate.

In accordance with certain embodiments of the invention, the first polymer-phase, the second polymer-phase, and the base-polymer phase independently from each other may comprise a respective polyethylene resin or a respective blend of a plurality of polyethylenes. For example, the first polymer-phase, the second polymer-phase, and the base-polymer phase independently from each other may comprise respective blends of polyethylenes and includes one or more of the following: (i) one or more linear low density polyethylenes (LLDPE); (ii) one or more non-linear low density polyethylenes; (iii) optionally one or more high density polyethylenes (HDPE); and (iv) optionally one or more ethylene/α-olefin copolymers. In accordance with certain embodiments of the invention, the first polymer-phase may include at least one polymer from each of groups (i) through (iv), in which each polymer is unique from the others (e.g., the ethylene/α-olefin copolymer is different from the LLDPE). Alternatively, the first polymer-phase may be devoid of a HDPE and/or an ethylene/α-olefin copolymer.

In accordance with certain embodiments of the invention, the multilayer film, the first skin layer, the second skin layer, or the base layer independently from each other may comprise from about 20 to about 50% by weight of the one or more LLDPEs, such as at least about any of the following: 20, 22, 25, 28, 30, 32, and 35% by weight of the one or more LLDPEs, and/or at most about any of the following: 50, 48, 45, 42, 40, 38, and 35% by weight of the one or more LLDPEs. Additionally or alternatively, the first-polymer-phase, the second-polymer phase, and the base-polymer phase independently from each other may comprise from about 40 to about 75% by weight of the one or more LLDPEs, such as at least about any of the following: 40, 42, 44, 46, 48, 50, 52, 54, 56, 58, and 60% by weight of the one or more LLDPEs, and/or at most about any of the following: 75, 72, 70, 68, 66, 64, 62, and 60% by weight of the one or more LLDPEs.

In accordance with certain embodiments of the invention, the multilayer film, the first skin layer, the second skin layer, or the base layer independently from each other may comprise from about 5 to about 30% by weight of the one or more ethylene/α-olefin copolymers, such as at least about any of the following: 5, 8, 10, 12, 15, 18, and 20% by weight of the one or more ethylene/α-olefin copolymers, and/or at most about any of the following: 30, 28, 25, 22, and 20% by weight of the one or more ethylene/α-olefin copolymers. Additionally or alternatively, the first-polymer-phase, the second-polymer phase, and the base-polymer phase independently from each other may comprise from about 10 to about 45% by weight of the one or more ethylene/α-olefin copolymers, such as at least about any of the following: 10, 12, 15, 18, 20, 22, 25, 28, and 30% by weight of the one or more ethylene/α-olefin copolymers, and/or at most about any of the following: 45, 42, 40, 38, 36, 34, 32, and 30% by weight of the one or more ethylene/α-olefin copolymers. Additionally or alternatively, the multilayer film, the first skin layer, the second skin layer, or the base layer independently from each other may comprise from about 1 to about 15% by weight of the one or more HDPEs, such as at least about any of the following: 1, 2, 3, 4, 5, 6, 8, and 10% by weight of the one or more HDPEs, and/or at most about any of the following: 15, 14, 13, 12, and 10% by weight of the one or more HDPEs. Additionally or alternatively, the first-polymer-phase, the second-polymer phase, and the base-polymer phase independently from each other may comprise from about 5 to about 25% by weight of the one or more HDPEs, such as at least about any of the following: 5, 6, 7, 8, 9, 10, 12, and 15% by weight of the one or more HDPEs, and/or at most about any of the following: 25, 22, 20, 18, and 15% by weight of the one or more HDPEs. Additionally or alternatively, the multilayer film, the first skin layer, the second skin layer, or the base layer independently from each other may comprise from about 1 to about 15% by weight of the one or more non-linear low density polyethylenes, such as at least about any of the following: 1, 2, 3, 4, 5, 6, 8, and 10% by weight of the one or more HDPEs, and/or at most about any of the following: 15, 14, 13, 12, and 10% by weight of the one or more non-linear low density polyethylenes. Additionally or alternatively, the first-polymer-phase, the second-polymer phase, and the base-polymer phase independently from each other may comprise from about 5 to about 25% by weight of the one or more non-linear low density polyethylenes, such as at least about any of the following: 5, 6, 7, 8, 9, 10, 12, and 15% by weight of the one or more HDPEs, and/or at most about any of the following: 25, 22, 20, 18, and 15% by weight of the one or more non-linear low density polyethylenes.

In accordance with certain embodiments of the invention, the first-polymer-phase, the second-polymer phase, and the base-polymer phase independently from each other may comprise a first weight ratio between the one or more LLDPEs and the one or more HPDEs is from about 2:1 to about 7:1, such as at least about any of the following: 2:1, 2.5:1, 3:1, 3.5:1, 4:1, 4.5:1, and 5:1, and/or at most about any of the following: 7:1, 6.5:1, 6:1, 5.5:1, and 5:1. Additionally or alternatively, the first-polymer-phase, the second-polymer phase, and the base-polymer phase independently from each other may comprise a second weight ratio between the one or more LLDPEs and the one or more ethylene/α-olefin copolymers is from about 1:1 to about 4:1, such as at least about any of the following: 1:1, 1.25:1, 1.5:1, 1.75:1, 2:1, and 2.25:1, and/or at most about any of the following: 4:1, 3.75:1, 3.5:1, 3.25:1, 3:1, 2.75:1, 2.5:1, and 2.25:1. Additionally or alternatively, the first-polymer-phase, the second-polymer phase, and the base-polymer phase independently from each other may comprise a third weight ratio between the one or more ethylene/α-olefin copolymers and the one or more HDPEs is from about 1:1 to about 4:1, such as at least about any of the following: 1:1, 1.25:1, 1.5:1, 1.75:1, 2:1, 2.25:1, 2.5:1, and/or at most about any of the following: 4:1, 3.75:1, 3.5:1, 3.25:1, 3:1, 2.75:1, and 2.5:1.

In accordance with certain embodiments of the invention, the first-skin-layer polymeric composition, the second-skin-layer polymeric composition, and the base-layer polymeric composition are identical with the exception of their respective thickness.

In accordance with certain embodiments of the invention, the multi-layer film may have a total average thickness from about 10 to about 100 microns, such as at least about any of the following: 10, 12, 15, 18, 20, 22, 25, 28 and 30 microns, and/or at most about any of the following: 100, 80, 60, 40, 35, and 30 microns. Additionally or alternatively, the base layer may comprise an average base-layer thickness comprising from about 25% to about 80% of total average thickness, such as at least about any of the following: 25, 30, 35, 40, 45, 50, and 55% of the total average thickness, and/or at most about any of the following: 80, 75, 70, 65, 60, and 55% of the total average thickness. Additionally or alternatively, the first skin layer may comprise an average first-skin thickness comprising from about 5% to about 30% of total average thickness, such as at least about any of the following: 5, 8, 10, 12, 15, 18, and 20% of the total average thickness, and/or at most about any of the following: 30, 28, 25, 22, and 20% of the total average thickness. Additionally or alternatively, the second skin layer may comprise an average second-skin thickness comprising from about 5% to about 30% of total average thickness, such as at least about any of the following: 5, 8, 10, 12, 15, 18, and 20% of the total average thickness, and/or at most about any of the following: 30, 28, 25, 22, and 20% of the total average thickness.

In accordance with certain embodiments of the invention, the multi-layer film may have a total basis weight from about 10 to about 100 gsm, such as at least about any of the following: 10, 12, 15, 18, 20, 22, 25, 28, 30, 35, and 40 gsm, and/or at most about any of the following: 100, 90, 80, 70, 60, 50, and 40 gsm. Additionally or alternatively, the base layer may have a base-layer basis weight comprising from about 25% to about 80% of total basis weight, such as at least about any of the following: 25, 30, 35, 40, 45, 50, and 55% of the total basis weight, and/or at most about any of the following: 80, 75, 70, 65, 60, 58, 56, and 55% of the total basis weight. Additionally or alternatively, the first skin layer may comprise a first-skin basis weight comprising from about 5% to about 30% of total basis weight, such as at least about any of the following: 5, 8, 10, 12, 15, 18, and 20% of the total basis weight, and/or at most about any of the following: 30, 28, 25, 22, and 20% of the total basis weight. Additionally or alternatively, the second skin layer may comprise a second-skin basis weight comprising from about 5% to about 30% of total basis weight, such as at least about any of the following: 5, 8, 10, 12, 15, 18, and 20% of the total basis weight, and/or at most about any of the following: 30, 28, 25, 22, and 20% of the total basis weight.

In accordance with certain embodiments of the invention, the adhesive layer may comprise a hot melt adhesive. For example, the hot melt adhesive may comprise a synthetic rubber-based hot-melt adhesive, an olefinic hot-melt adhesive, or a composite hot-melt adhesive. These types of adhesives rapidly exhibit an adhesive force between the VPLI film and the nonwoven fabric. A synthetic rubber-based hot-melt adhesive, for example, may contain at least a thermoplastic elastomer (hereinafter referred to as a TPE). The synthetic rubber-based hot-melt adhesive may also contain a tackifier and/or a mineral oil or alternatively be devoid of a tackifier and/or a mineral oil. A TPE, for example, may include a styrenic TPE, which may be composed of a hard segment having a polystyrene structure and a soft segment. Examples of such styrenic TPEs include SBS (polystyrene-polybutadiene-polystyrene), SIS (polystyrene-polyisoprene-polystyrene), SEBS (polystyrene-polyethylene/polybutylene-polystyrene), and SEPS (polystyrene-polyethylene/polypropylene-polystyrene). An olefinic hot-melt adhesive may contain a polyolefin which is a thermoplastic resin, which may also contain a tackifier and/or a mineral oil, or alternatively be devoid of a tackifier and/or a mineral oil. The polyolefin, in accordance with certain embodiments of the invention may be a polymer of α-olefin. [0045]

The adhesive layer, in accordance with certain embodiments of the invention, may have an adhesive-layer basis weight from about 0.5 to about 10 gsm, such as at least about any of the following: 0.5, 1, 2, 3, 4, and 5 gsm, and/or at most about any of the following: 10, 9, 8, 7, 6, and 5 gsm. Additionally or alternatively, the adhesive layer may comprise comprises a continuous layer or a discontinuous layer. In accordance with certain embodiments of the invention, the discontinuous layer may include a plurality of individual and discrete adhesive deposition locations. Alternatively, the adhesive layer may comprise one or more continuous streaks, one or more discontinuous streaks, or a combination thereof. In accordance with certain embodiments of the invention, the adhesive layer may comprise one or more continuous streaks that do not overlap each other. Alternatively, the adhesive layer may comprise one or more continuous streaks, wherein a first plurality of continuous streaks define intersection regions defined by overlapping portions of the first plurality of continuous streaks.

In another aspect, the invention provides a method of forming a laminate, in which the method may comprise the following steps: (i) providing or forming a nonwoven fabric; (ii) providing or forming a vapor-permeable and liquid impermeable (VPLI) film; and (iii) directly or indirectly bonding the nonwoven fabric to the VPLI film via an adhesive layer. The VPLI film, in accordance with certain embodiments of the invention, may have (i) a moisture vapor transmission rate (MVTR) of at least about 2000 Mocon or g/m²/24 hours (e.g., from 2000 to 10000 Mocon or g/m²/24 hours) as determined according to EDNA/INDA Worldwide Strategic Methods: WSP 70.4(08), such as at least about any of the following: 2000, 2200, 2400, 2500, 2600, 2800, 3000, 3200, 3400, 3500, 3600, 3800, 4000, 4200, 4400, 4500, 4600, 4800, and 5000 Mocon or g/m²/24 hours as determined according to WSP 70.4(08), and/or at most about any of the following: 10000, 9000, 8000, 7500, 7400, 7200, 7000, 6800, 6600, 6500, 6400, 6200, 6000, 5800, 5600, 5500, 5400, 5200, and 5000 Mocon or g/m²/24 hours as determined according to WSP 70.4(08), and/or (ii) a puncture resistance of at least about 5 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min, such as at least about any of the following: 5, 6 7, 8, 9, 10, 12, 14, and 15 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min, and/or at most about any of the following: 50, 45, 40, 35, 30, 25, 20, 18, 16, and 15 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min.

In accordance with certain embodiments of the invention, the VPLI film may be formed via a cast film extrusion operation. When the VPLI film comprises a multi-layer film, the multi-layer film may be formed by a cast film co-extrusion operation. In accordance with certain embodiments of the invention, the multi-layer film may comprise from 2 to 8 individual layers, as noted above. Additionally or alternatively, each of the individual layers may be formed from a single polymeric source (e.g., identical polymeric composition forming each of the individual layers). Additionally or alternatively, the method may comprises a step of incrementally stretching the laminate to impart a plurality of micropores within the VPLI film. Additionally or alternatively, the method may comprise a step of incrementally stretching the VPLI film prior to bonding the nonwoven fabric to the VPLI film.

In yet another aspect, the present invention provides an article of protective clothing. The article of protective clothing may be formed at least partially (e.g., substantially all with the exception of any stitching or connecting or closing means) from a laminate as described and disclosed herein. The article of protective clothing, for example, may comprise coveralls, gowns, smocks, pants, headwear, and shoe covers.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein

1. A laminate, comprising:
a nonwoven fabric; and
a vapor-permeable and liquid impermeable (VPLI) film bonded to the nonwoven fabric by an adhesive layer located between the nonwoven fabric and the VPLI film;
wherein the VPLI film has (i) a moisture vapor transmission rate (MVTR) of at least about 2000 g/m²/24 hours as determined according to EDNA/INDA Worldwide Strategic Methods: WSP 70.4(08), and/or (ii) a puncture resistance of at least about 5 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min.

2. The laminate of claim 1, wherein the nonwoven fabric comprises at least one spunbond layer, at least one meltblown layer, at least one carded layer, or any combinations thereof.

3. The laminate of claim 2, wherein the nonwoven fabric comprises one or more spunbond layers.

4. The laminate of claim 1, wherein the nonwoven fabric has a basis weight from about 40 to about 150 grams-per-square meter (gsm).

5. The laminate of claim 4, wherein the nonwoven fabric includes a plurality of fibers comprising a high density polyethylene, an ethylene/1-octene copolymer, a polypropylene, or a combination thereof.

6. The laminate of claim 5, wherein the plurality of fibers comprises continuous spunbond fibers comprising a high density polyethylene.

7. The laminate of claim 6, wherein the high density polyethylene comprises a melt flow rate (MFR) of from about 5 to about 30 g/10 min as determined by ASTM D1238 (190 C°/2.16 kg).

8. The laminate of claim 1, wherein the VPLI film comprises a single layer film having a single-layer-polymeric composition, and wherein the single layer film comprises a microporous film, and wherein the single layer film has (i) a basis weight from about 10 to about 100 gsm, and/or (ii) a total thickness from about 10 to about 100 microns.

9. The laminate of claim 8, wherein the single-layer-polymeric composition comprises a polymer-phase and a filler dispersed throughout the polymer-phase, wherein the polymer-phase comprises the blend of polyethylenes and includes one or more of the following: (i) one or more linear low density polyethylenes (LLDPE); (ii) one or more non-linear low density polyethylenes; (iii) optionally one or more high density polyethylenes (HDPE); and (iv) optionally one or more ethylene/α-olefin copolymers.

10. The laminate of claim 9, wherein the VPLI comprises from about 20 to about 50% by weight of the one or more LLDPEs, from about 5 to about 30% by weight of the one or more ethylene/α-olefin copolymers, from about 1 to about 15% by weight of the one or more HDPEs, from about 1 to about 15% by weight of the one or more non-linear low density polyethylenes, and from about 5 to about 25% by weight of the one or more non-linear low density polyethylenes, wherein the sum of each equals 100%.

11. The laminate of claim 10, wherein the polymer-phase comprises one or more of the following: (i) a first weight ratio between the one or more LLDPEs and the one or more HPDEs is from about 2:1 to about 7:1, (ii) a second weight ratio between the one or more LLDPEs and the one or more ethylene/α-olefin copolymers is from about 1:1 to about 4:1, and (iii) a third weight ratio between the one or more ethylene/α-olefin copolymers and the one or more HDPEs is from about 1:1 to about 4:1.

12. The laminate of claim 1, wherein the VPLI film comprises a multi-layer film comprising from 2 to 8 individual layers, wherein at least one of the individual layers is a microporous layer.

13. The laminate of claim 12, wherein the multi-layer film includes a base layer, a first skin layer, and a second skin layer, and wherein the first skin layer comprises a first-skin-layer polymeric composition, the second skin layer comprises a second-skin-layer polymeric composition, and the base layer comprises a base-layer polymeric composition; wherein each of the first-skin-layer polymeric composition, the second-skin-layer polymeric composition, and the base-layer polymeric composition comprises respective polymer-phases and respective fillers dispersed throughout the respective polymer-phases.

14. The laminate of claim 13, wherein the first-skin-layer polymeric composition, the second-skin-layer polymeric composition, and the base-layer polymeric composition are the same.

15. A method of forming a laminate, comprising:
(i) providing or forming a nonwoven fabric;
(ii) providing or forming a vapor-permeable and liquid impermeable (VPLI) film; and
(iii) directly or indirectly bonding the nonwoven fabric to the VPLI film via an adhesive layer;
wherein the VPLI film has (i) a moisture vapor transmission rate (MVTR) of at least about 2000 g/m²/24 hours as determined according to EDNA/INDA Worldwide Strategic Methods: WSP 70.4(08) and/or (ii) a puncture resistance of at least about 5 N as determined according to UNI EN 863:1997+UNI EN 14325:2005 Par. 4.10+UNI EN 13034:2009 Par. 4.1 with test conditions of (20+/−2)° C. at (65+/−4)% U.R. with an extension rate of 100 mm/min.

16. The method of claim 15, wherein the VPLI film comprises a multi-layer film formed by a cast film co-extrusion operation.

17. The method of claim 16, wherein the multi-layer film comprises from 2 to 8 individual layers each formed from a single polymeric source.

18. The method of claim 15, further comprising a step of incrementally stretching the laminate to impart a plurality of micropores within the VPLI film.

19. The method of claim 15, further comprising a step of incrementally stretching the VPLI film prior to bonding the nonwoven fabric to the VPLI film.

20. An article of protective clothing, comprising a laminate according to claim 1, wherein the article of protective clothing comprises coveralls, gowns, smocks, pants, headwear, and shoe covers.
